(19) United States
(12) Patent Application Publication
(10) Pub. No.: US 2026/0319119 A1
(43) Pub. Date: Oct. 15, 2026

(54) METHOD AND DEVICE FOR SEISMIC DATA LOW-FREQUENCY RECOVERY CONSTRAINED BY REFLECTION STRUCTURE

(71) Applicants: China National Petroleum Corporation, Beijing (CN); BGP Inc., China National Petroleum Corporation, Baoding, Hebei (CN); CNPC Exploration Software Co., Ltd, Beijing (CN)

(72) Inventors: Dingyu XIONG, Baoding, Hebei (CN); Yue NIU, Baoding, Hebei (CN); Jianlei ZHANG, Baoding, Hebei (CN); Wenchuang WANG, Baoding, Hebei (CN); Yunfeng FANG, Baoding, Hebei (CN); Yanhui WU, Baoding, Hebei (CN)

(73) Assignees: China National Petroleum Corporation, Beijing (CN); BGP Inc., China National Petroleum Corporation, Baoding, Hebei (CN); CNPC Exploration Software Co., Ltd, Beijing (CN)

(21) Appl. No.: 19/491,478

(22) PCT Filed: Dec. 1, 2023
(86) PCT No.: PCT/CN2023/135904

§ 371 Date: Dec. 9, 2025

(30) Foreign Application Priority Data
Sep. 25, 2023 (CN) 202311246292.2

(51) Int. Cl. G01V 1/36

(52) U.S. Cl. CPC G01V 1/368

(57) ABSTRACT

A method for seismic data low-frequency recovery constrained by a reflection structure, which belongs to the field of seismic data processing. The method comprises: on the basis of original seismic data, determining a highest frequency to be recovered corresponding to low-frequency seismic data to be recovered; by using the original seismic data and an inversion algorithm, determining a reflection structure characterization operator; by using a reflection coefficient and the reflection structure characterization operator, constructing a regularization constraint term, and establishing a target functional for the reflection coefficient; reversely solving the target functional for the reflection coefficient to obtain the reflection coefficient; performing low-frequency filtering on the reflection coefficient to obtain the low-frequency seismic data; performing high-pass filtering on the original seismic data to obtain high-frequency seismic data; and combining the low-frequency seismic data and the high-frequency seismic data, so as to obtain seismic data after low-frequency recovery. The provided method can ensure the reliability of low-frequency seismic data, enhance the resolution of seismic data, and improve the accuracy of full-waveform velocity inversion. Further provided is a device for seismic data low-frequency recovery constrained by a reflection structure.

### FIELD OF THE INVENTION

The present disclosure relates to the technical field of seismic data processing, in particular to a method for seismic data low-frequency recovery constrained by a reflection structure and a device for seismic data low-frequency recovery constrained by a reflection structure.

### BACKGROUND OF THE INVENTION

Due to an influence of factors such as excitation, receiving and surface wave interference, low-frequency data is subjected to suppression, pollution and distortion in actual seismic records, and low-frequency data of some frequency bands are even missed in some cases. For example, during data collection, excitation of the low-frequency data is difficult; or during data receiving, a natural frequency of an existing wave detector has a certain suppression effect on the low-frequency data. For another example, the low-frequency data is subjected to suppression in the actual seismic records due to low-frequency data pollution by the surface wave interference. Though there are various suppression methods for surface wave interference, their suppression processes damage low-frequency data inevitably. In addition, an investigation analysis for field environmental noise shows that frequency components of environmental noise are not favorable white noise distribution, low-frequency data thereof usually have stronger energy. Missing of the low-frequency data increases a seismic wavelet side lobe, aggravates an interference effect of different stratums and reduces a resolution of seismic data. The low-frequency data also plays an indispensable role in wave impedance inversion.

In the prior art, for supplementing an influence of low-frequency missing on the wave impedance inversion, a method of establishing a low-frequency module by well-logging data along-horizon interpolation is usually adopted. However, the low-frequency module constructed by this method is subject to accuracy of well logging calibration and horizon interpretation, so reliability of low-frequency data is hardly ensured. Low-frequency missing also significantly reduces accuracy of full-waveform velocity inversion.

### SUMMARY OF THE INVENTION

For solving the technical problems in the prior art that the reliability of low-frequency seismic data is low, accuracy of full-waveform velocity inversion is reduced, and the resolution of seismic data is reduced, the present disclosure provides a method and device for seismic data low-frequency recovery constrained by a reflection structure. By adopting the method, the reliability of low-frequency seismic data can be ensured, the resolution of seismic data can be enhanced, and the accuracy of the full-waveform velocity inversion can be improved.

For achieving the above objective, a method for seismic data low-frequency recovery constrained by a reflection structure provided by the present disclosure includes the following steps: obtaining original seismic data, and determining a to-be-recovered highest frequency corresponding to to-be-recovered low-frequency seismic data according to the original seismic data; determining a reflection structure characterization operator by using the original seismic data and an inversion algorithm; constructing a regularization constraint term by using a reflection coefficient and the reflection structure characterization operator, and establishing a target functional for the reflection coefficient through the regularization constraint term; reversely solving the target functional for the reflection coefficient to obtain the reflection coefficient; performing low-frequency filtering with a high cut-off frequency as the to-be-recovered highest frequency on the reflection coefficient to obtain low-frequency seismic data; performing high-pass filtering with a low cut-off frequency as the to-be-recovered highest frequency on the original seismic data to obtain high-frequency seismic data; and combining the low-frequency seismic data and the high-frequency seismic data to obtain seismic data after low-frequency recovery.

Further, determining the to-be-recovered highest frequency corresponding to the to-be-recovered low-frequency seismic data according to the original seismic data includes: determining data with amplitude energy less than set energy from the original seismic data as the low-frequency seismic data; and determining a highest frequency of the low-frequency seismic data as the to-be-recovered highest frequency.

Further, determining the reflection structure characterization operator by using the original seismic data and the inversion algorithm includes: establishing a target functional of the reflection structure characterization operator by using the seismic data and the reflection structure characterization operator; and reversely solving the target functional of the reflection structure characterization operator by using a conjugate gradient method to determine the reflection structure characterization operator.

Further, the target functional of the reflection structure characterization operator is established through the following manner:

$$e = {\sum }_{x = 1}^{{n}_{x}} {\sum }_{t = 1}^{{n}_{t}} {[ d ( x , t ) - {\sum }_{y = - {l}_{x} , y \neq 0}^{lx} {\sum }_{τ = {l}_{t} , τ \neq 0}^{{l}_{t}} h ( y , τ ) d ( x - y , t - τ ) ]}^{2} ;$$

where e is the target functional of the reflection structure characterization operator, x is a position of an earth surface, t is reflection time, namely, different seismic channels, d(x,t) is the original seismic data, h(y,τ) is the reflection structure characterization operator, τ is a sampling point of the reflection structure characterization operator in a time direction, y is a sampling point of the operator in a position direction of the seismic channels, nₓ is the number of the seismic channels, nₜ is the number of samples of seismic recording time, lₓ is a spatial length of the reflection structure characterization operator, and lₜ is a time length of the reflection structure characterization operator.

Further, constructing the regularization constraint term by using the reflection coefficient and the reflection structure characterization operator, and establishing the target functional for the reflection coefficient through the regularization constraint term includes: establishing an inversion target functional by using a convolution model; establishing a reflection coefficient sparse structure function as a first regularization constraint term of the inversion target functional by using the reflection coefficient; establishing a function of the reflection structure as a second regularization constraint term of the inversion target functional by using the reflection structure characterization operator; and establishing the target functional for the reflection coefficient by using the inversion target functional, the first regularization constraint term and the second regularization constraint term.

Further, the inversion target functional is established through the following manner:

$$e ( r ) = {\sum }_{x = 1}^{{n}_{x}} {\sum }_{t = 1}^{{n}_{t}} {[ d ( x , t ) - {\sum }_{τ = 1}^{{n}_{t}} w ( τ ) r ( x , t - τ ) ]}^{2} ;$$

where e(r) is the inversion target functional, w(τ) is a seismic wavelet, τ is a sampling point of the seismic wavelet in a time direction, nₓ is the number of seismic channels, nₜ is the number of samples of seismic recording time, and r(x,t) is the reflection coefficient.

Further, the seismic wavelet is obtained through the following manner: obtaining a seismic wavelet amplitude spectrum by fitting from an amplitude spectrum of the original seismic data by using a spectrum simulation method; and obtaining the seismic wavelet by performing Fourier transform on the seismic wavelet amplitude spectrum.

Further, the reflection coefficient sparse structure function is established through the following manner:

$${ϕ}_{1} ( r ) = {\sum }_{x = 1}^{{n}_{x}} {\sum }_{t = 1}^{{n}_{t}} ln ( 1 + \frac{{r}^{2} ( x , t )}{2} ) ;$$

where φ₁(r) is the reflection coefficient sparse structure function.

Further, the function of the reflection structure is established through the following manner:

$${ϕ}_{2} ( r ) = {‖ HFr ‖}_{2}^{2} ;$$

where φ₂(r) is the function of the reflection structure, H is a matrix composed of the reflection structure characterization operator, F is a matrix composed of a low-pass filtering operator with a high cut-off frequency as f₀, and r is a matrix composed of the reflection coefficient.

Further, the target functional for the reflection coefficient is established through the following manner:

α(r)=e(r)+λ₁φ₁(r)+λ₂φ₂(r);
where α(r) is the target functional for the reflection coefficient, λ₁ is a regulator of the first regularization constraint term, and λ₂ is a regulator of the second regularization constraint term. Further, reversely solving the target functional for the reflection coefficient to obtain the reflection coefficient includes: reversely solving the target functional for the reflection coefficient by using iterative reweighted least squares to obtain the reflection coefficient.

Further, combining the low-frequency seismic data and the high-frequency seismic data to obtain the seismic data after the low-frequency recovery includes: performing weighted combination on the low-frequency seismic data and the high-frequency seismic data in a frequency domain to obtain a combination result; and transforming the combination result to a time domain to obtain the seismic data after the low-frequency recovery.

A second aspect of the present disclosure provides a device for seismic data low-frequency recovery constrained by a reflection structure. The device for the seismic data low-frequency recovery constrained by the reflection structure includes a to-be-recovered highest frequency determining module, configured to obtain original seismic data, and determine a to-be-recovered highest frequency corresponding to to-be-recovered low-frequency seismic data according to the original seismic data; a reflection structure characterization operator determining module, configured to determine a reflection structure characterization operator by using the original seismic data and an inversion algorithm; a determining module for a target functional for a reflection coefficient, configured to construct a regularization constraint term by using a reflection coefficient and the reflection structure characterization operator, and establish a target functional for the reflection coefficient through the regularization constraint term; a reflection coefficient determining module, configured to reversely solve the target functional for the reflection coefficient to obtain the reflection coefficient; a low-frequency seismic data determining module, configured to perform low-frequency filtering with a high cut-off frequency as the to-be-recovered highest frequency on the reflection coefficient to obtain low-frequency seismic data; a high-frequency seismic data determining module, configured to perform high-pass filtering with a low cut-off frequency as the to-be-recovered highest frequency on the original seismic data to obtain high-frequency seismic data; and a combination module, configured to combine the low-frequency seismic data and the high-frequency seismic data to obtain seismic data after low-frequency recovery.

Through the technical solution provided by the present disclosure, the present disclosure at least has the following technical effects.

Through the method for the seismic data low-frequency recovery constrained by the reflection structure in the present disclosure, the original seismic data is obtained first, the to-be-recovered highest frequency corresponding to the to-be-recovered low-frequency seismic data is determined according to the original seismic data, the reflection structure characterization operator is determined by using the original seismic data and the inversion algorithm, then the regularization constraint term is constructed by using the reflection coefficient and the reflection structure characterization operator, the target functional for the reflection coefficient is established through the regularization constraint term, and the target functional for the reflection coefficient is reversely solved to obtain the reflection coefficient. Low-frequency filtering with the high cut-off frequency as the to-be-recovered highest frequency is performed on the reflection coefficient to obtain the low-frequency seismic data, and high-pass filtering with the low cut-off frequency as the to-be-recovered highest frequency is performed on the original seismic data to obtain the high-frequency seismic data. Then the low-frequency seismic data and the high-frequency seismic data are combined to obtain the seismic data after the low-frequency recovery. According to the method for the seismic data low-frequency recovery constrained by the reflection structure provided by the present disclosure, the reliability of low-frequency seismic data can be ensured, the resolution of seismic data can be enhanced, and the accuracy of full-waveform velocity inversion can be improved.

Other features and advantages of the present disclosure are described in detail in the detailed description below.

### BRIEF DESCRIPTION OF DRAWINGS

Accompanying drawings are used for providing further understanding for embodiments of the present disclosure, constitute a part of the specification and, together with the following detailed description, are used for explaining the embodiments of the present disclosure without constituting a limitation on the embodiments of the present disclosure. In the accompanying drawings:

FIG. 1 is a flowchart of a method for seismic data low-frequency recovery constrained by a reflection structure provided by an embodiment of the present disclosure.

FIG. 2 is a schematic diagram of seismic model data synthesized by using a complicated model in a method for seismic data low-frequency recovery constrained by a reflection structure provided by an embodiment of the present disclosure.

FIG. 3 is a schematic diagram of low-frequency model data after performing high cut-off frequency low-pass filtering on seismic model data in a method for seismic data low-frequency recovery constrained by a reflection structure provided by an embodiment of the present disclosure.

FIG. 4 is a schematic diagram of high-frequency model data after performing low cut-off frequency high-pass filtering on seismic model data in a method for seismic data low-frequency recovery constrained by a reflection structure provided by an embodiment of the present disclosure.

FIG. 5 is a schematic diagram of low-frequency seismic data after recovering seismic model data in a method for seismic data low-frequency recovery constrained by a reflection structure provided by an embodiment of the present disclosure.

FIG. 6 is a schematic diagram of seismic data after low-frequency recovery of seismic model data in a method for seismic data low-frequency recovery constrained by a reflection structure provided by an embodiment of the present disclosure.

FIG. 7 is a schematic diagram of actual original seismic data of a certain oil field in a method for seismic data low-frequency recovery constrained by a reflection structure provided by an embodiment of the present disclosure.

FIG. 8 is to-be-recovered low-frequency seismic data below 10 Hz of actual original seismic data in a method for seismic data low-frequency recovery constrained by a reflection structure provided by an embodiment of the present disclosure.

FIG. 9 is low-frequency seismic data after recovering actual original seismic data in a method for seismic data low-frequency recovery constrained by a reflection structure provided by an embodiment of the present disclosure.

FIG. 10 is seismic data after low-frequency recovery of actual original seismic data in a method for seismic data low-frequency recovery constrained by a reflection structure provided by an embodiment of the present disclosure.

FIG. 11 is a schematic diagram of a device for seismic data low-frequency recovery constrained by a reflection structure provided by an embodiment of the present disclosure.

### DETAILED DESCRIPTION OF THE EMBODIMENTS

Specific implementations of embodiments of the present disclosure are described in detail hereinafter with reference to the accompanying drawings. It is to be understood that the specific implementations described here are only used for describing and explaining the embodiments of the present disclosure instead of limiting the embodiments of the present disclosure.

It is to be noted that without conflicts, the embodiments in the present disclosure and features in the embodiments may be mutually combined.

In the present disclosure, without a contrary description, position words used such as “upper, lower, top and bottom” are usually words for describing mutual position relationships of respective components in a direction shown in the accompanying drawings or in a vertical, perpendicular or gravity direction.

The present disclosure is described in detail below with reference to the accompanying drawings and in combination with embodiments.

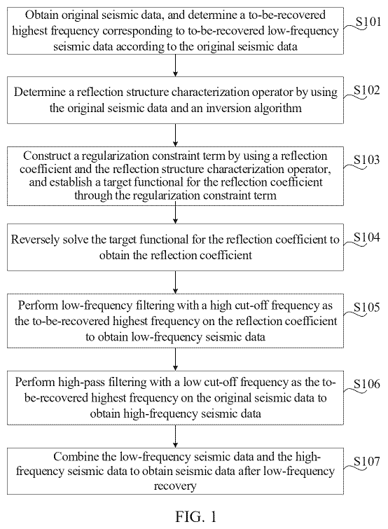

Please refer to FIG. 1, an embodiment of the present disclosure provides a method for seismic data low-frequency recovery constrained by a reflection structure. The method includes the following steps: S101: original seismic data is obtained, and a to-be-recovered highest frequency corresponding to to-be-recovered low-frequency seismic data is determined according to the original seismic data; S102: a reflection structure characterization operator is determined by using the original seismic data and an inversion algorithm; S103: a regularization constraint term is constructed by using a reflection coefficient and the reflection structure characterization operator, and a target functional for the reflection coefficient is established through the regularization constraint term; S104: the target functional for the reflection coefficient is reversely solved to obtain the reflection coefficient; S105: low-frequency filtering with a high cut-off frequency as the to-be-recovered highest frequency is performed on the reflection coefficient to obtain low-frequency seismic data; S106: high-pass filtering with a low cut-off frequency as the to-be-recovered highest frequency is performed on the original seismic data to obtain high-frequency seismic data; and S107: the low-frequency seismic data and the high-frequency seismic data are combined to obtain seismic data after low-frequency recovery.

Specifically, in the implementations of the present disclosure, the original seismic data is obtained first, the to-be-recovered highest frequency corresponding to the to-be-recovered low-frequency seismic data is determined according to the original seismic data, the reflection structure characterization operator is determined by using the original seismic data and the inversion algorithm, then the regularization constraint term is constructed by using the reflection coefficient and the reflection structure characterization operator, the target functional for the reflection coefficient is established through the regularization constraint term, and the target functional for the reflection coefficient is reversely solved to obtain the reflection coefficient. Low-frequency filtering with the high cut-off frequency as the to-be-recovered highest frequency is performed on the reflection coefficient to obtain the low-frequency seismic data; and high-pass filtering with the low cut-off frequency as the to-be-recovered highest frequency is performed on the original seismic data to obtain the high-frequency seismic data. Then the low-frequency seismic data and the high-frequency seismic data are combined to obtain the seismic data after low-frequency recovery.

According to the method for seismic data low-frequency recovery constrained by the reflection structure provided by the present disclosure, the reliability of low-frequency seismic data can be ensured, the resolution of seismic data can be enhanced, and the accuracy of full-waveform velocity inversion can be improved.

Step S101 is performed first: the original seismic data is obtained, and the to-be-recovered highest frequency corresponding to the to-be-recovered low-frequency seismic data is determined according to the original seismic data.

Further, determining the to-be-recovered highest frequency corresponding to the to-be-recovered low-frequency seismic data according to the original seismic data includes: determining data with amplitude energy less than set energy from the original seismic data as the low-frequency seismic data; and determining a highest frequency of the low-frequency seismic data as the to-be-recovered highest frequency.

Specifically, in the implementations of the present disclosure, the original seismic data d(x,t) is obtained first, where t is reflection time, and * is a position of an earth surface, namely, different seismic channels. The original seismic data d(x,t) is overall sectional data of post-stack two-dimensional data of missing low-frequency seismic data. Spectral analysis is performed on the original seismic data d(x,t), a piece of data with amplitude energy (amplitude value) less than the set energy is determined as the to-be-recovered low-frequency seismic data, and a highest frequency of the low-frequency seismic data is determined as the to-be-recovered highest frequency f₀.

Then step S102 is performed: the reflection structure characterization operator is determined by using the original seismic data and the inversion algorithm.

Further, determining the reflection structure characterization operator by using the original seismic data and the inversion algorithm includes: establishing a target functional of the reflection structure characterization operator by using the seismic data and the reflection structure characterization operator; and reversely solving the target functional of the reflection structure characterization operator by using a conjugate gradient method to determine the reflection structure characterization operator.

Specifically, in the implementations of the present disclosure, valid data in actual seismic data has correlation in space, namely, seismic data sections have a certain predictive relationship in a time direction and a spatial direction. The reflection structure is a geometric feature and an energy change feature of a seismic reflection axis in space and represents continuity and predictability of the seismic data in space. The reflection structure characterization operator h(x,t) is a time-space operator for describing a spatial relationship and an energy relationship of the reflection structure, may be regarded as any sampling point in a seismic section, and may be obtained by using its surrounding sampling points and reflection structure operator convolution, namely, linear delineation can be made for a relationship between the sampling points on the seismic data section through the operator. Thus, based on spatial coherence of the seismic data, the reflection structure characterization operator h(x,t) may be calculated by using the original seismic data d(x,t):

first, the target functional of the reflection structure characterization operator is established by using the seismic data and the reflection structure characterization operator:

$$e = {\sum }_{x = 1}^{{n}_{x}} {\sum }_{t = 1}^{{n}_{t}} {[ d ( x , t ) - {\sum }_{y = - {l}_{x} , y \neq 0}^{lx} {\sum }_{τ = {l}_{t} , τ \neq 0}^{{l}_{t}} h ( y , τ ) d ( x - y , t - τ ) ]}^{2} ;$$

where e is the target functional of the reflection structure characterization operator, d(x,t) is the original seismic data, h(x,t) is the reflection structure characterization operator, nₓ is the number of seismic channels, nₜ is the number of samples of seismic recording time, lₓ is a spatial length of the reflection structure characterization operator, and lₜ is a time length of the reflection structure characterization operator. The target functional indicates a meaning that an optimal characterization operator obtained by solving may minimize error energy e between data values predicted by convolution of any data point on the seismic data section, lₓ*lₜ data points adjacent thereto and the characterization operator.

Then, the target functional of the reflection structure characterization operator is reversely solved by using the conjugate gradient method to determine the reflection structure characterization operator h(x,t).

Then step S103 is performed: the regularization constraint term is constructed by using the reflection coefficient and the reflection structure characterization operator, and the target functional for the reflection coefficient is established through the regularization constraint term.

Further, constructing the regularization constraint term by using the reflection coefficient and the reflection structure characterization operator, and establishing the target functional for the reflection coefficient through the regularization constraint term includes: establishing an inversion target functional by using a convolution model; establishing a reflection coefficient sparse structure function as a first regularization constraint term of the inversion target functional by using the reflection coefficient; establishing a function of the reflection structure as a second regularization constraint term of the inversion target functional by using the reflection structure characterization operator; and establishing the target functional for the reflection coefficient by using the inversion target functional, the first regularization constraint term and the second regularization constraint term.

Specifically, in the implementations of the present disclosure, the inversion target functional is established by using the convolution model d=w*r

$$e ( r ) = {\sum }_{x = 1}^{{n}_{x}} {\sum }_{t = 1}^{{n}_{t}} {[ d ( x , t ) - {\sum }_{τ = 1}^{{n}_{t}} w ( τ ) r ( x , t - τ ) ]}^{2} ;$$

where e(r) is the inversion target functional, w(τ) is a seismic wavelet, nₓ is the number of seismic channels, nₜ is the number of samples of seismic recording time, and r(x,t) is the reflection coefficient.

Further, the seismic wavelet is obtained through the following manner: a seismic wavelet amplitude spectrum is obtained by fitting from an amplitude spectrum of the original seismic data by using a spectrum simulation method; and the seismic wavelet w(τ) is obtained by performing Fourier transform on the seismic wavelet amplitude spectrum.

Further, the reflection coefficient sparse structure function is established according to a probability distribution of the reflection coefficient and an assumption of the reflection coefficient having sparsity:

$${ϕ}_{1} ( r ) = {\sum }_{x = 1}^{{n}_{x}} {\sum }_{t = 1}^{{n}_{t}} ln ( 1 + \frac{{r}^{2} ( x , t )}{2} ) ;$$

where φ₁(r) is the reflection coefficient sparse structure function.

Further, the function of the reflection structure is established according to the reflection coefficient and a seismic record having the same predictability:

$${ϕ}_{2} ( r ) = {‖ HFr ‖}_{2}^{2} ;$$

where φ₂(r) is the function of the reflection structure.

H is a matrix composed of the reflection structure characterization operator:

$$H = [ \begin{matrix}{h}_{1} ( x , t ) & 0 & 0 & 0 \\ 0 & {h}_{2} ( x , t ) & 0 & 0 \\ 0 & 0 & L & 0 \\ 0 & 0 & 0 & {h}_{n} ( x , t )\end{matrix} ] ;$$

where hₙ(x,t) is a reflection structure characterization operator solved corresponding to an n-th seismic channel.

F is a matrix composed of a low-pass filtering operator with a high cut-off frequency as f₀ and represents a process of low-pass filtering of the reflection coefficient. The method uses a sinc function to constitute a low-pass filter, then:

$$F = [ \begin{matrix}sin c ( x ) \\ sin c ( x ) \\ L \\ sin c ( x )\end{matrix} ] ;$$

where sinc(x) is a filter operator value used.

r is a matrix composed of the reflection coefficient:

$$r = [ \begin{matrix}{r}_{1} ( x , t ) \\ {r}_{2} ( x , t ) \\ L \\ {r}_{n} ( x , t )\end{matrix} ] ;$$

where rₙ(x,t) is a to-be-solved reflection coefficient of the n-th seismic channel.

Further, the target functional for the reflection coefficient is established through the following manner:

α(r)=e(r)+λ₁φ₁(r)+λ₂φ₂(r);

where α(r) is the target functional for the reflection coefficient, λ₁ is a regulator of the first regularization constraint term, and λ₂ is a regulator of the second regularization constraint term. The regulator may be determined according to actual conditions and used for adjusting an influence of regularization constraint on a result. The greater λ₁ is, the more apparent sparsity of time of the reflection coefficient is, and the greater λ₂ is, the higher the continuity of space of the reflection structure is.

Then step S104 is performed: the target functional for the reflection coefficient is reversely solved to obtain the reflection coefficient.

Further, reversely solving the target functional for the reflection coefficient to obtain the reflection coefficient includes: reversely solving the target functional α(r) for the reflection coefficient by using iterative reweighted least squares (IRLS) to obtain the reflection coefficient r(x,t).

Then, step S105 is performed: low-frequency filtering with the high cut-off frequency as the to-be-recovered highest frequency f₀ is performed on the reflection coefficient r(x,t) to obtain the low-frequency seismic data s(x,t).

Then, step S106 is performed: high-pass filtering with the low cut-off frequency as the to-be-recovered highest frequency f₀ is performed on the original seismic data r(x,t) to obtain the high-frequency seismic data.

Finally, step S107 is performed: the low-frequency seismic data and the high-frequency seismic data are combined to obtain the seismic data after low-frequency recovery.

Further, combining the low-frequency seismic data and the high-frequency seismic data to obtain the seismic data after low-frequency recovery includes: performing weighted combination on the low-frequency seismic data and the high-frequency seismic data in a frequency domain to obtain a combination result; and transforming the combination result to a time domain to obtain the seismic data after low-frequency recovery.

Specifically, in the implementations of the present disclosure, the low-frequency seismic data s(x,t) and the high-frequency seismic data are respectively transformed to a frequency domain, and weighted combination is performed on frequency spectrums of the two pieces of data within a transition band to obtain the combination result. Then, the combination result is transformed to the time domain to form a seismic record after low-frequency seismic data recovery.

### Example 1

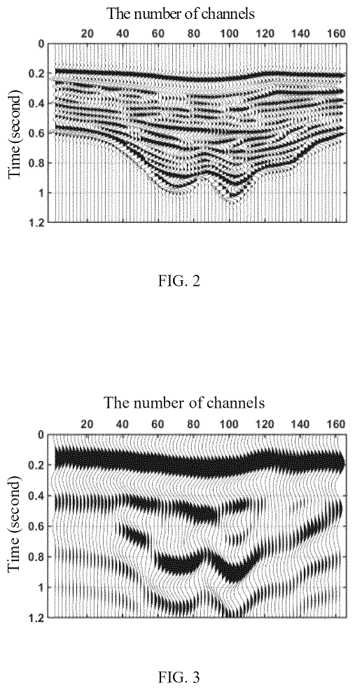

For verifying validity of the example, seismic model data shown in FIG. 2 is synthesized by using a complicated model, and low-pass filtering with a high cut-off frequency f₀=10 Hz is performed on the seismic model data shown in FIG. 2 to obtain the low-frequency model data shown in FIG. 3.

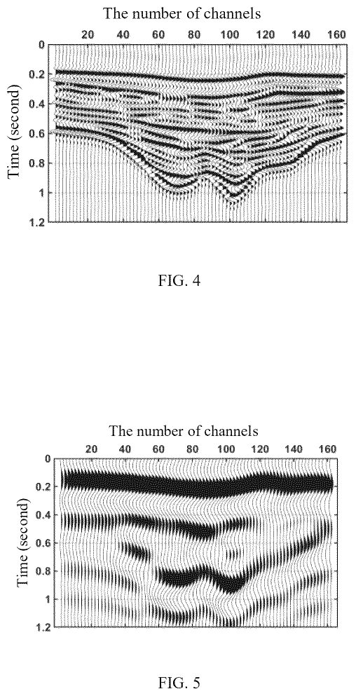

High-pass filtering with the low cut-off frequency f₀=10 Hz is performed on the seismic model data shown in FIG. 2 to obtain the high-frequency seismic data shown in FIG. 4. FIG. 4 is the high-frequency model data with missing 10 Hz or below. FIG. 5 is the low-frequency seismic data recovered from FIG. 4 by using the method of the example, and the low-frequency seismic data has high consistency compared with the low-frequency model data in FIG. 3. FIG. 6 is seismic data after stacking the low-frequency seismic data recovered in FIG. 5 and the high-frequency model data in FIG. 4, and the seismic model data shown in FIG. 2 is effectively recovered.

### Example 2

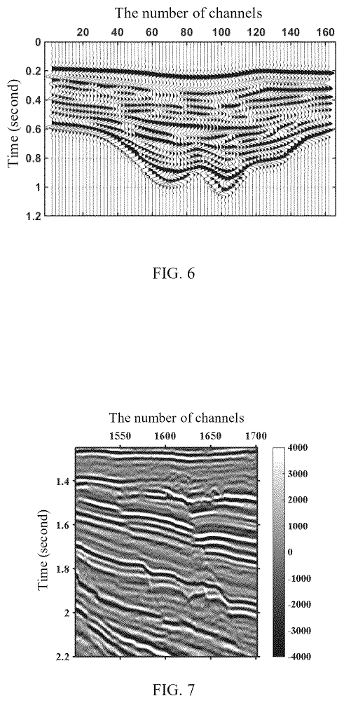

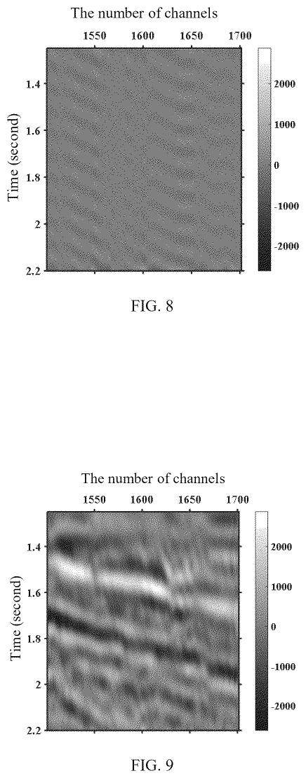

Actual original seismic data d(x,t) of a certain oil field shown in FIG. 7 is obtained. A spectral analysis is performed on the original seismic data d(x,t) As shown in FIG. 8, it is determined that the data has weak energy at 10 Hz or below, and the low-frequency seismic data at 10 Hz or below needs to be recovered, namely, the to-be-recovered highest frequency f₀ corresponding to the low-frequency seismic data is 10 Hz. The seismic wavelet amplitude spectrum is obtained by fitting from the amplitude spectrum of the original seismic data by using the spectrum simulation method, and the seismic wavelet w(t) is obtained by performing Fourier transform on the seismic wavelet amplitude spectrum.

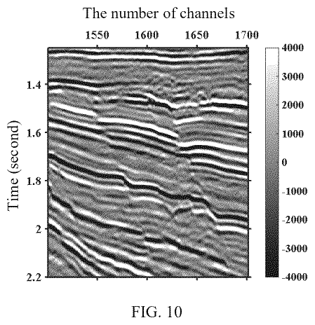

By solving a problem of the lease squares, the reflection structure characterization operator h(x,t) is determined by using the original seismic data and the inversion algorithm. The reflection structure characterization operator h(x,t) represents continuity and predictability of the seismic data in space, so the error energy between predicted data after multiplying original data points, a plurality of adjacent data points and the characterization operator is minimum. The target functional for the reflection coefficient is established by using the convolution model, namely, the seismic data may be regarded as a convolution of a sequence of the reflection coefficient and the seismic wavelet, and solving the sequence of the reflection coefficient from the seismic data is a corresponding inverse problem, which is implemented by solving the target functional for the reflection coefficient. The inversion problem usually has multiplicity of solution. For obtaining a more accurate result, the target functional is solved according to a regularization theory, and the regularization theory is to reduce singularity of the solution by adding a constraint term to an inversion target function. Then, the regularization constraint term is constructed respectively: according to the probability distribution of the reflection coefficient and an assumption of the reflection coefficient having sparsity, the reflection coefficient sparse structure function is established as the first regularization constraint term, and a position of an event in the time direction is reflected in a constrained result; and according to the reflection coefficient and the seismic record having the same predictability, the function of the reflection structure is established as the second regularization constraint term, and continuity of the event in the space direction is reflected in a constrained result. The two constraint terms are multiplied respectively by corresponding coefficients, the two coefficients may be adjusted by a user, and the greater the coefficient is, the more apparent the influence of the corresponding constraint terms on the result is. In the example, both λ₁ and λ₂ are 0.25, and meanwhile, the sparsity of the reflection coefficient and the transverse continuity of the reflection structure are ensured. Then, the target functional α(r) for the reflection coefficient with the added regularization constraint term is solved by using the IRLS algorithm to obtain the reflection coefficient r(x,t) The low-frequency seismic data of the reflection coefficient is the same as a low-frequency component of the seismic data, the low-frequency filter with the high cut-off frequency as 10 Hz is used, a transition band of the filter is 7 Hz to 13 Hz, and the low-frequency seismic data with the reflection coefficient of 10 Hz or below is separated out to obtain the low-frequency seismic data shown in FIG. 9. Then, the high-pass filter with the low cut-off frequency as 10 Hz is used, a transition band of the filter is also 7 Hz to 13 Hz, and low-frequency data at 10 Hz or below is filtered out from the original seismic data in FIG. 6 to obtain the high-frequency seismic data. Then, spectrum combination is performed, in the frequency domain, on the low-frequency seismic data of the reflection coefficient and the high-frequency seismic data with the low-frequency seismic data being filtered out, weighted combination is performed on frequency spectrums of the two pieces of data within the transition band, namely, weighted summation is performed on frequency spectrum amplitude values, for the low-frequency seismic data of the reflection coefficient, a weight is 1 at 7 Hz, a weight is 0 at 13 Hz, the weight is linearly reduced within the transition band, for the high-frequency seismic data of the original seismic data, a weight is 0 at 7 Hz, a weight is 1 at 13 Hz, and the weight is linearly increased within the transition band. The frequency spectrum after combination is transformed to the time domain to finally obtain the seismic data after low-frequency recovery shown in FIG. 10, and a low-frequency recovery process constrained by the reflection structure is completed.

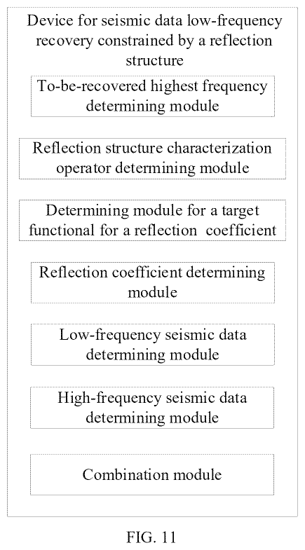

It may be seen that the example effectively recovers the low-frequency seismic data of the actual original seismic data, and the seismic data after recovery of the low-frequency seismic data can more accurately reflect a seismic response of an actual underground structure and an oil and gas reservoir. Please refer to FIG. 11, a second aspect of the present disclosure provides a device for seismic data low-frequency recovery constrained by a reflection structure. The device for the seismic data low-frequency recovery constrained by the reflection structure includes a to-be-recovered highest frequency determining module, configured to obtain original seismic data, and determine a to-be-recovered highest frequency corresponding to to-be-recovered low-frequency seismic data according to the original seismic data; a reflection structure characterization operator determining module, configured to determine a reflection structure characterization operator by using the original seismic data and an inversion algorithm; a determining module for a target functional for a reflection coefficient, configured to construct a regularization constraint term by using a reflection coefficient and the reflection structure characterization operator, and establish a target functional for the reflection coefficient through the regularization constraint term; a reflection coefficient determining module, configured to reversely solve the target functional for the reflection coefficient to obtain the reflection coefficient; a low-frequency seismic data determining module, configured to perform low-frequency filtering with a high cut-off frequency as the to-be-recovered highest frequency on the reflection coefficient to obtain low-frequency seismic data; a high-frequency seismic data determining module, configured to perform high-pass filtering with a low cut-off frequency as the to-be-recovered highest frequency on the original seismic data to obtain high-frequency seismic data; and a combination module, configured to combine the low-frequency seismic data and the high-frequency seismic data to obtain seismic data after low-frequency recovery.

Preferred implementations of the present disclosure are described in detail above with reference to the accompanying drawings. However, the present disclosure is not limited to the specific details in the above implementations. Within the scope of the technical concept of the present disclosure, various simple variations may be made to the technical solutions of the present disclosure, and these simple variations fall within the protection scope of the present disclosure.

It also needs to be noted that various specific technical features described in the specific implementations above, without contradictions, may be combined in any appropriate manner. For avoiding unnecessary repetitions, the present disclosure does not describe various possible combination manners separately.

In addition, various different implementations of the present disclosure may also be combined at will, and should also be regarded as the contents disclosed by the present disclosure as long as the concept of the present disclosure is not violated.

1. A method for seismic data low-frequency recovery constrained by a reflection structure, comprising:
obtaining original seismic data, and determining a to-be-recovered highest frequency corresponding to to-be-recovered low-frequency seismic data according to the original seismic data;
determining a reflection structure characterization operator by using the original seismic data and an inversion algorithm;
constructing a regularization constraint term by using a reflection coefficient and the reflection structure characterization operator, and establishing a target functional for the reflection coefficient through the regularization constraint term;
reversely solving the target functional for the reflection coefficient to obtain the reflection coefficient;
performing low-frequency filtering with a high cut-off frequency as the to-be-recovered highest frequency on the reflection coefficient to obtain low-frequency seismic data;
performing high-pass filtering with a low cut-off frequency as the to-be-recovered highest frequency on the original seismic data to obtain high-frequency seismic data; and
combining the low-frequency seismic data and the high-frequency seismic data to obtain seismic data after low-frequency recovery.

2. The method for the seismic data low-frequency recovery constrained by the reflection structure according to claim 1, wherein determining the to-be-recovered highest frequency corresponding to the to-be-recovered low-frequency seismic data according to the original seismic data comprises:
determining data with amplitude energy less than set energy from the original seismic data as the low-frequency seismic data; and
determining a highest frequency of the low-frequency seismic data as the to-be-recovered highest frequency.

3. The method for the seismic data low-frequency recovery constrained by the reflection structure according to claim 1, wherein determining the reflection structure characterization operator by using the original seismic data and the inversion algorithm comprises:
establishing a target functional of the reflection structure characterization operator by using the seismic data and the reflection structure characterization operator; and
reversely solving the target functional of the reflection structure characterization operator by using a conjugate gradient method to determine the reflection structure characterization operator.

4. The method for the seismic data low-frequency recovery constrained by the reflection structure according to claim 3, wherein the target functional of the reflection structure characterization operator is established through the following manner:
$$e = {\sum }_{x = 1}^{{n}_{x}} {\sum }_{t = 1}^{{n}_{t}} {[ d ( x , t ) - {\sum }_{y = - {l}_{x} , y \neq 0}^{lx} {\sum }_{τ = {l}_{t} , τ \neq 0}^{{l}_{t}} h ( y , τ ) d ( x - y , t - τ ) ]}^{2} ;$$
wherein e is the target functional of the reflection structure characterization operator, x is a position of an earth surface, t is reflection time, namely, different seismic channels, d(x,t) is the original seismic data, h(x,t) is the reflection structure characterization operator, τ is a sampling point of the reflection structure characterization operator in a time direction, y is a sampling point of the operator in a position direction of the seismic channels, nₓ is the number of the seismic channels, nₜ is the number of samples of seismic recording time, lₓ is a spatial length of the reflection structure characterization operator, and lₜ is a time length of the reflection structure characterization operator.

5. The method for the seismic data low-frequency recovery constrained by the reflection structure according to claim 1, wherein constructing the regularization constraint term by using the reflection coefficient and the reflection structure characterization operator, and establishing the target functional for the reflection coefficient through the regularization constraint term comprises:
establishing an inversion target functional by using a convolution model;
establishing a reflection coefficient sparse structure function as a first regularization constraint term of the inversion target functional by using the reflection coefficient;
establishing a function of the reflection structure as a second regularization constraint term of the inversion target functional by using the reflection structure characterization operator; and
establishing the target functional for the reflection coefficient by using the inversion target functional, the first regularization constraint term and the second regularization constraint term.

6. The method for the seismic data low-frequency recovery constrained by the reflection structure according to claim 5, wherein the inversion target functional is established through the following manner:
$$e ( r ) = {\sum }_{x = 1}^{{n}_{x}} {\sum }_{t = 1}^{{n}_{t}} {[ d ( x , t ) - {\sum }_{τ = 1}^{{n}_{t}} w ( τ ) r ( x , t - τ ) ]}^{2} ;$$
wherein e(r) is the inversion target functional, w(τ) is a seismic wavelet, τ is a sampling point of the seismic wavelet in a time direction, nₓ is the number of seismic channels, nₜ is the number of samples of seismic recording time, and r(x,t) is the reflection coefficient.

7. The method for the seismic data low-frequency recovery constrained by the reflection structure according to claim 6, wherein the seismic wavelet is obtained through the following manner:
obtaining a seismic wavelet amplitude spectrum by fitting from an amplitude spectrum of the original seismic data by using a spectrum simulation method; and
obtaining the seismic wavelet by performing Fourier transform on the seismic wavelet amplitude spectrum.

8. The method for the seismic data low-frequency recovery constrained by the reflection structure according to claim 7, wherein the reflection coefficient sparse structure function is established through the following manner:
$${ϕ}_{1} ( r ) = {\sum }_{x = 1}^{{n}_{x}} {\sum }_{t = 1}^{{n}_{t}} ln ( 1 + \frac{{r}^{2} ( x , t )}{2} ) ;$$
wherein φ₁(r) is the reflection coefficient sparse structure function.

9. The method for the seismic data low-frequency recovery constrained by the reflection structure according to claim 8, wherein the function of the reflection structure is established through the following manner:
$${ϕ}_{2} ( r ) = {‖ HFr ‖}_{2}^{2} ;$$
wherein φ₂(r) is the function of the reflection structure, H is a matrix composed of the reflection structure characterization operator, F is a matrix composed of a low-pass filtering operator with a high cut-off frequency as f₀, and r is a matrix composed of the reflection coefficient.

10. The method for the seismic data low-frequency recovery constrained by the reflection structure according to claim 9, wherein the target functional for the reflection coefficient is established through the following manner:
α(r)=e(r)+λ₁φ₁(r)+λ₂φ₂(r);
wherein α(r) is the target functional for the reflection coefficient, λ₁ is a regulator of the first regularization constraint term, and λ₂ is a regulator of the second regularization constraint term.

11. The method for the seismic data low-frequency recovery constrained by the reflection structure according to claim 1, wherein reversely solving the target functional for the reflection coefficient to obtain the reflection coefficient comprises:
reversely solving the target functional for the reflection coefficient by using iterative reweighted least squares to obtain the reflection coefficient.

12. The method for the seismic data low-frequency recovery constrained by the reflection structure according to claim 1, wherein combining the low-frequency seismic data and the high-frequency seismic data to obtain the seismic data after low-frequency recovery comprises:
performing weighted combination on the low-frequency seismic data and the high-frequency seismic data in a frequency domain to obtain a combination result; and
transforming the combination result to a time domain to obtain the seismic data after low-frequency recovery.

13. A device for seismic data low-frequency recovery constrained by a reflection structure, comprising:
a to-be-recovered highest frequency determining module, configured to obtain original seismic data, and determine a to-be-recovered highest frequency corresponding to to-be-recovered low-frequency seismic data according to the original seismic data;
a reflection structure characterization operator determining module, configured to determine a reflection structure characterization operator by using the original seismic data and an inversion algorithm;
a determining module for a target functional for a reflection coefficient, configured to construct a regularization constraint term by using a reflection coefficient and the reflection structure characterization operator, and establish a target functional for the reflection coefficient through the regularization constraint term;
a reflection coefficient determining module, configured to reversely solve the target functional for the reflection coefficient to obtain the reflection coefficient;
a low-frequency seismic data determining module, configured to perform low-frequency filtering with a high cut-off frequency as the to-be-recovered highest frequency on the reflection coefficient to obtain low-frequency seismic data;
a high-frequency seismic data determining module, configured to perform high-pass filtering with a low cut-off frequency as the to-be-recovered highest frequency on the original seismic data to obtain high-frequency seismic data; and
a combination module, configured to combine the low-frequency seismic data and the high-frequency seismic data to obtain seismic data after low-frequency recovery.
